(19) United States
(12) Patent Application Publication
(10) Pub. No.: US 2015/0039455 A1
(43) Pub. Date: Feb. 5, 2015

(54) Universal Interface Card Swipe Terminal Point of Sale System With Multiple Mobile Wallets/Payment Applications

(71) Applicant: Sergio Luciani, Sarasota, FL (US)

(72) Inventor: Sergio Luciani, Sarasota, FL (US)

(21) Appl. No.: 14/447,066

(22) Filed: Jul. 30, 2014

Related U.S. Application Data
(60) Provisional application No. 61/958,567, filed on Jul. 31, 2013.

(51) Int. Cl. G06Q 20/20; G06Q 20/36; G06Q 20/22

(52) U.S. Cl. CPC G06Q 20/204; G06Q 20/227; G06Q 20/36
USPC 705/17

(57) ABSTRACT

An invention is disclosed whereby Merchant Card Swipe Terminals, as well as Tablet or PC Computer-based POS systems having card swiping devices are enabled via a software-based solution to interface with multiple mobile payment/mobile wallet solutions and provide check out functionality for corresponding mobile payment platforms. The software is implemented within the card swiper unit and via remove cloud-based server environment connected via the internet to the card swiper unit.

### BACKGROUND OF THE INVENTION

### Current State of the Art

Today, almost all merchants, whether brick and mortar or e-commerce (online-based) businesses, accept electronic payments (e.g., credit cards, debit cards, gift cards, in addition to private payment solutions such as PayPal® and Google Wallet®) as tender for transactions. The emergence of smart phones contributed to the development of mobile payment solutions which now account for a significant portion of e-commerce, and are poised to become a large if not preponderant portion of the electronic payments ecosystem. Electronic payments are also accepted by increasing numbers of vending machines, kiosks, automated tellers and other systems without a human merchant needed to conduct the transaction or to process payment as tender for the transaction. The underlying system that allows merchants to accept payment for, clear these transactions and receive the appropriate credit and acknowledgment, while providing the customer with the necessary link to their credit/debit solutions, consists of an architecture involving at least some of the following parties and components, defined as follows:

Acquiring Bank: The Acquiring Bank holds the contract for providing payment processing services to the merchant. The merchant account is a contract under which the Acquiring Bank extends a line of credit to a merchant who wishes to accept credit card transactions. The Acquiring Bank holds all the risk on every transaction as well as the operation of every registered acquiring ISO/MSP and their sub-agents and are responsible for all Association fines.

Association: The consumer payment system whose members are the financial institutions that issue payment cards and/or sign merchant to accept payment cards.

Back-End Network: The platform that takes captured transactions from the Front-End Network and settles them through the Interchange system. The back-end generates daily ACH files for merchant settlement. Other functions typically handed on the back-end include chargeback handling, retrieval request and monthly statements. Usually provided by the Processor or Acquiring/Issuing Bank and/or their third party agents.

BIN-IIN: A number used to identify the issuer. Part of a payment card number, typically the first six digits of a payment card number assigned to a bank that issues payment cards (e.g. credit cards). BIN-IIN services allow an issuing bank to receive requests for settlement of transaction involving the “issued card” via the Interchange back to the merchant.

Cardholder: Authorized user of a payment card (e.g. credit, debit, or gift card). See also, Customer.

Closed-loop card solution: A card recognized by the front end gateway of a processor as a financial instrument whose clearance process should be routed outside of the Interchange system.

Customer: Individual having a mobile payment application downloaded on his/her mobile device (which typically is a mobile phone, smart phone, or tablet computer). Also called Mobile Application User.

Front-end Network: The platform that the credit card terminal/gateway communicates with when approving a transaction. The front-end is responsible for the authorization and capture portion of a credit card transaction. Additional front-end platform interconnections may be required to support ACH and debit transaction. Usually provided by the acquiring bank, processor, or processor's approved/certified third party.

Independent Sales Organization (ISO)/Member Services Provider (MSP) (“Processor”): Entity that solicits merchants on behalf of an Acquiring Bank for payment card acceptance and enables card payments from customers. Acquirer's generally hold responsibility for providing customer service, merchant-level support, merchant-level compliance with Association rules and underwriting of merchant accounts. Sometimes called Processor.

Interchange: The process and communication network, by which all parties involved in a credit card transaction (i.e., processors, acquirer, issuers, etc.) manage the processing, clearing and settlement of credit card transactions, including the assessment and collection and/or distribution of fees between all parties.

Issuing Bank: A financial institution that issues payment cards and maintains a contract with cardholders for repayment.

Merchant: Authorized acceptor of payment cards for the payment of goods and services provided to customer.

Mobile Payment Platforms/Solutions (“MPS”): A software/hardware based system that enables mobile devices such as telephones to communicate with parties involved in a credit or debit transaction and providing the means by which credit data pertinent to the owner of the device is transmitted to some of the parties involved to settle a transaction. The Platform can perform processing functions directly to an acquiring bank or can be integrated with one or more processor to perform clearing functions.

Payment Gateway: The virtual device (software) used by the merchant to communicate information to the Acquirer's Front-End Network. The Gateway is certified as PCI compliant and can collect or retrieve credit data information from a “Vault” to be forwarded along with the total amount due to the issuing bank of the credit instrument for approval of the transaction. It is the means by which a physical point of sale terminal, located at a merchant's retail outlet, communicates and settles credit/debit transactions. Payment gateways interface with a merchant's POS system and pass that data to a Front-End Authorization Network. Usually provided by Acquiring Bank, Processor or processor's agent (ISO) or third party integrated with processor/Acquiring Bank.

POS/Terminal: The physical or virtual device used by the merchant to communicate information to the Acquirer's Front-End Network. Usually provided by acquiring bank, processor, or processor's agent (ISO) or third party integrated with processor/Acquiring Bank.

Financial Instrument/Card: A traditional magnetic stripe card recognizable by the BIN-IIN management system or by the issuing bank as a special card whose requests will be redirected to the “Server.” The card contains information relative to the merchant and the Terminal ID Vault System: software environment where processors store sensitive data such as credit and personal data to be used for many purposes including applications by a third party which can use such data as related to their application without need to actually have direct access.

The Server: A computing device receiving and sending information from the BIN-IIN management system. A closed-loop card solution or the issuing bank regarding activing (swipes) relative to the financial instrument/card. The information includes transaction amount and merchant and terminal data. The server receives and sends information form all Mobile Payment Platforms attempting to clear a transaction from a merchant's POS and communicates back to the MPS.

Virtual Terminal: Processor's administrative system which gives access to merchant of all activity occurring in merchant settlement of credit-debit transactions.

### BRIEF BACKGROUND ON CURRENT STATE OF THE ART OF TRADITIONAL CREDIT CARD TRANSACTION PROCESSING

Currently when a merchant and a processor execute an agreement so that the processor will handle the merchant's electronic payment transactions, the processor creates a merchant account for the merchant that identifies the merchant and defines the parameters related to that agreement. Such agreement defines the types of transactions that the merchant is authorized to undertake and includes merchant ID, processor ID and a merchant account ID. This data is stored in a secure environment usually identified as Payment Card Industry (“PCI”) compliant. Once the payment interface unit is configured so that communication with the processor occurs within the required parameters, including a merchant profile and identification of the specific point of sale (“POS” or “Terminal”) unit, this allows for identification of the parameters related to the merchant agreement with the processor and of the specific POS terminal unit involved in the transaction. The payment interface unit will create a transaction request based on the customer profile (or “customer ID”), the processor application, the merchant profile (or “merchant ID”), the specific POS Terminal ID, and the total payment amount due. Accordingly, third party vendors are utilized to install and configure the payment interface units at the merchant POS Terminal sites, so that they address the processor's application requirements and enabling communications channels between the specific merchant and specific processor. Within this framework, credit-debit processing of transactions between consumer and merchant (C to B) or between merchants (B to B) are undertaken with either (a) card-present status (where the actual card having a magnetic stripe is swiped on a magnetic card reader, said magnetic stripe containing two encoded tracks of information about the card, the cardholder and the issuing financial institution), or (b) card-not-present status (where card information is conveyed orally/manually via a telephone a fax or other media input). E-commerce transactions in general qualify as card not present status as the data is manually entered into the merchant system remotely, with various systems integrated to address and minimize the likelihood of fraud.

### BRIEF BACKGROUND ON CURRENT STATE OF THE ART OF CREDIT CARD PROCESSING USING MOBILE DEVICE SOLUTIONS

The emergence of mobile e-commerce and the prevalent use of mobile devices (such as smart phones and tablets) by the general public has brought a new dimension to credit card transactions with the adoption of mobile payment platforms, where consumers make use of their mobile devices and enabled wireless internet connections to a payment clearing environment (Mobile Payment Platform/System (“MPS”)) to pay for goods or services using their mobile device. The transaction is initiated by the consumer via a mobile payment application resident on the consumer/customer's mobile device which communicates to the MPS, which in turn transmits to the processor the relevant total due for the transaction, the merchant ID, and consumer's credit card information stored on the mobile device.

Card Swiper units currently present in the market process credit card transactions through a magnetic card reader that recognized the data contained on the magnetic strip of credit cards and a communication device that connects the Merchant and the Issuing Bank via a Payment Processor. Recently, both Tablets and PC based-Terminal/POS systems have incorporated these functionalities as they are commonly furnished with a card swipe device interfaced with a Terminal/POS system. The emergence of mobile device-based payment solutions requires modifications to the existing hardware and software of each Merchant's Terminal/Point of Sale Systems in order to enable each individual mobile payment solution to be interfaced with the individual Mobile Payment Platforms/Wallets. Given the diversity of merchant specific architecture present in the market, and the multiplicity of mobile payment and mobile wallet solutions, implementation of mobile payments has been hampered. Tablet and PC-based Terminal/POS systems face the same diversity and complexity in integrating multiple Mobile Payment solutions. Current state of the art requires integration of each platform and each mobile payment solution individually.

### SUMMARY OF THE INVENTION

An invention is disclosed whereby Merchant Card Swipe Terminals, such as PC or Tablet computer-based Terminal/POS systems having card swiping capability, are enabled via a software-based solution to interface with multiple mobile payment (i.e. mobile wallet) payment gateways and provide check out functionality for corresponding mobile payment platforms. The software-based solution may reside within the Terminal/POS, or in a remote server environment, such as a cloud-based environment, connected via the internet to the Terminal/POS. The software-based solution enables the following functionalities:

1) Bi-directional communication with multiple (1-n) mobile payment platforms/wallets;
2) Bi-direction communication with a remote server hosting program management tools;
3) Monitoring and operation of resident printer or printer (RS-232 or similar used in the art) port; and
4) Monitoring and communication with connection (RS-232 or similar used in the art) port of card swiper device.
The remote server environment also contains a series of software management tools allowing for:
1) Bi-directional communication with the Terminal/POS via an internet connection and any peripherally connected devices (such as a printer or RS-232 or similar port);
2) Communicate with the Mobile Payment Platform and with the Mobile Payment Application/Wallet;
3) Remotely access the Merchant Terminal/Card Swipe Unit software to implement updates, patches, and modify/add/subtract the implemented Mobile Wallet Solutions.

The invention allows for a customer's selection from multiple Mobile Payment Solutions by implementing a static interface to allow multiple MPS's which can be chosen using the customer's mobile device via optical recognition (such as via a matrix code, QR code, or bar code) or via a static near-frequency communication (“NFC”) device (such as radio or Bluetooth®). These interfaces contain pertinent data to complete the transaction, including Merchant ID and Terminal/POS ID. When communication is established by the customer or merchant selecting the appropriate mobile payment solution, the payment system queries the appropriate payment server (wallet) gateway and completes the transaction.

The logic of the present invention provides the basis not only for check out credit card transactions but also for translation of multiple instruments of transactions.

### BRIEF DESCRIPTION OF THE DRAWINGS

FIG. 1. shows a schematic of one preferred embodiment of the invention, outlining the basic architecture of the Card Swipe terminal “Device” containing software for the card payment application and a Wallet Selector Application to select from multiple payment applications, Cash Register which can display multiple optic codes (or NFC signal) and Customer Mobile Payment Application resident on Mobile Phone, herein disclosed by the present invention.

FIG. 2. shows a schematic of a cloud-based management system allowing for remote updating and management of the resident software of the card swipe terminal software.

### DESCRIPTION OF THE VARIOUS EMBODIMENTS OF THE INVENTION

To achieve the foregoing utility in accordance with the purpose of the invention, preferred embodiments are described as follows.

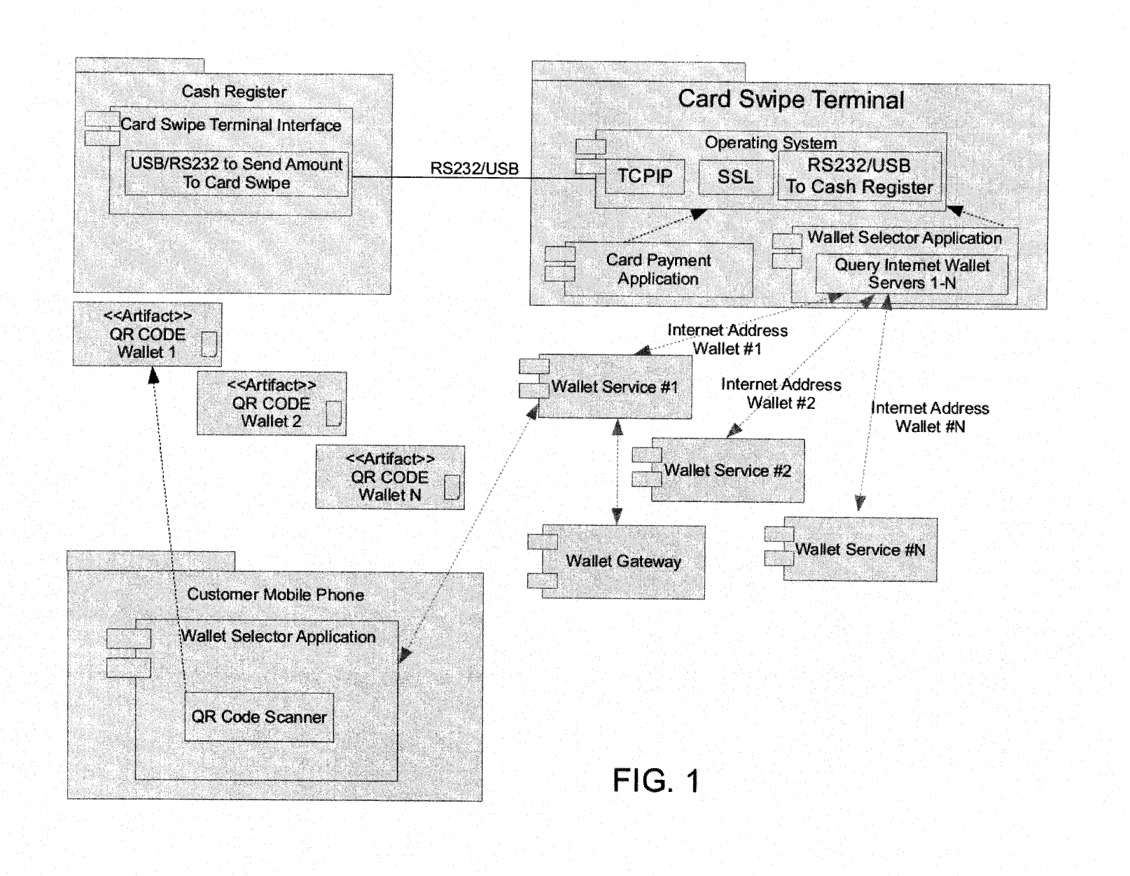

FIG. 1 shows a process and architecture for selecting from one of multiple possible mobile payment gateways on a single Terminal/POS system having either an internal or externally-connected card swiper unit for reading magnetic cards (i.e. credit cards) such as Veriphone® model VX510 or Ingenico® model ICT-220 via RS232 or similar connection means known in the art, and having basic internet connectivity and telecommunication functions. Once a total due is transmitted to the card swiper element of the Terminal/POS system, a software program (resident in either a remote server connected to the Terminal via internet, or resident on the Terminal or a peripherally-connected (via RS-232 or similar means) Card Swiper Unit is queried upon each transaction. This software program allows for access to multiple MPS service platforms and generates the appropriate optical interface matrix code (i.e. matrix or QR code or barcode) content for the appropriate Mobile Wallet/Payment Service Gateway, and is displayed to the customer via computer monitor or similar display means known in the art.

After the merchant receives verbal confirmation from the customer that the customer would like to use a specific Mobile Wallet/Payment Solution to pay for the transaction, the merchant generates the matrix code by selecting from a number of hotkeys located on the Terminal or Card Swiper that correspond to one of a number of Mobile Wallet/Payment options, or by the customer being presented with the same options on a display device or similar means and selecting the appropriate payment option. The customer, possessing a mobile device (i.e. smart phone) with radio and near-frequency communication capabilities, mobile data/internet functionality, and optical scanning capabilities, and having a mobile payment application designed to utilize one or more of these functions, scans the displayed matrix code. By scanning this optical interface, the MPS is contacted and enabled to process the transaction on behalf of the Mobile Wallet Service User (the customer) using the financial instrument information that is resident on the user's mobile application, and transmit acknowledgment of such transaction request for payment result back to the Terminal/Card Swiper. The Terminal unit prints acknowledgment of payment received and sends via RS-232 to the Terminal/POS system acknowledgment of such transaction being settled. The Customer likewise receives acknowledgment of payment being completed on their mobile device via the MPS.

A second preferred embodiment of the invention is a variant of the first preferred embodiment as shown in FIG. 1, where in lieu of the appropriate matrix code being queried and displayed to the customer, the customer is presented with a number of static optical interfaces (i.e. matrix or QR codes or barcodes) located at or near the Terminal/POS that correspond to different Mobile Wallet/Payment Applications. The customer identifies the appropriate optical interface desired to be used to complete payment and scans it using the customer's mobile device. The optical interface acts as a redirect to the pertinent MPS which is notified of an attempt to settle a transaction relative to the specific merchant and POS data transmitted via the matrix code. Data relative to total due on the transaction is retrieved by the MPS from the software located on Terminal/Card Swiper or via the remote cloud server connection and is paired with the customer attempting to pay for the transaction. The MPS contacts the Merchant's Processor, obtains transaction approval, settles the transaction and contacts the Terminal via direct or remote interface. The Terminal unit prints acknowledgment of payment received and sends via RS-232 to the Terminal/POS system acknowledgment of such transaction being settled. The Customer likewise receives acknowledgment of payment being completed on their mobile device via the MPS. As an alternative to optical selection interface, the software may contain an automatic script that queries the total of the transaction through all of the mobile wallets and upon recognizing the appropriate mobile wallet solution is then enabled to clear the transaction.

A third preferred embodiment of the invention is a variant of the second preferred embodiment, where in lieu of a series of static matrix or QR codes being displayed to the customer, the software resident on the Terminal/POS System emits a NFC signal and responds to any communication handshake attempts by short range radio device such as the customer's smart phone by establishing a connection with the customer's preferred Mobile Wallet/Payment application communication protocol resident in the software library related to a specific Mobile payment application. A NFC (radio, Bluetooth®) device interfaces with the Terminal/POS System and is set to a receive mode. Once communication is established and the Mobile Wallet/payment Application is identified, the appropriate MPS is contacted and enabled to process the transaction on behalf of the customer using the financial instrument information that is resident on the user's mobile application or on the MPS server's environment and transmits acknowledgment of such transaction request for payment result back to the Terminal/Card Swiper. The Terminal unit prints acknowledgment of payment received and sends via RS-232 to the Terminal/POS system acknowledgment of such transaction being settled. The Customer likewise receives acknowledgment of payment being completed on their mobile device via the MPS.

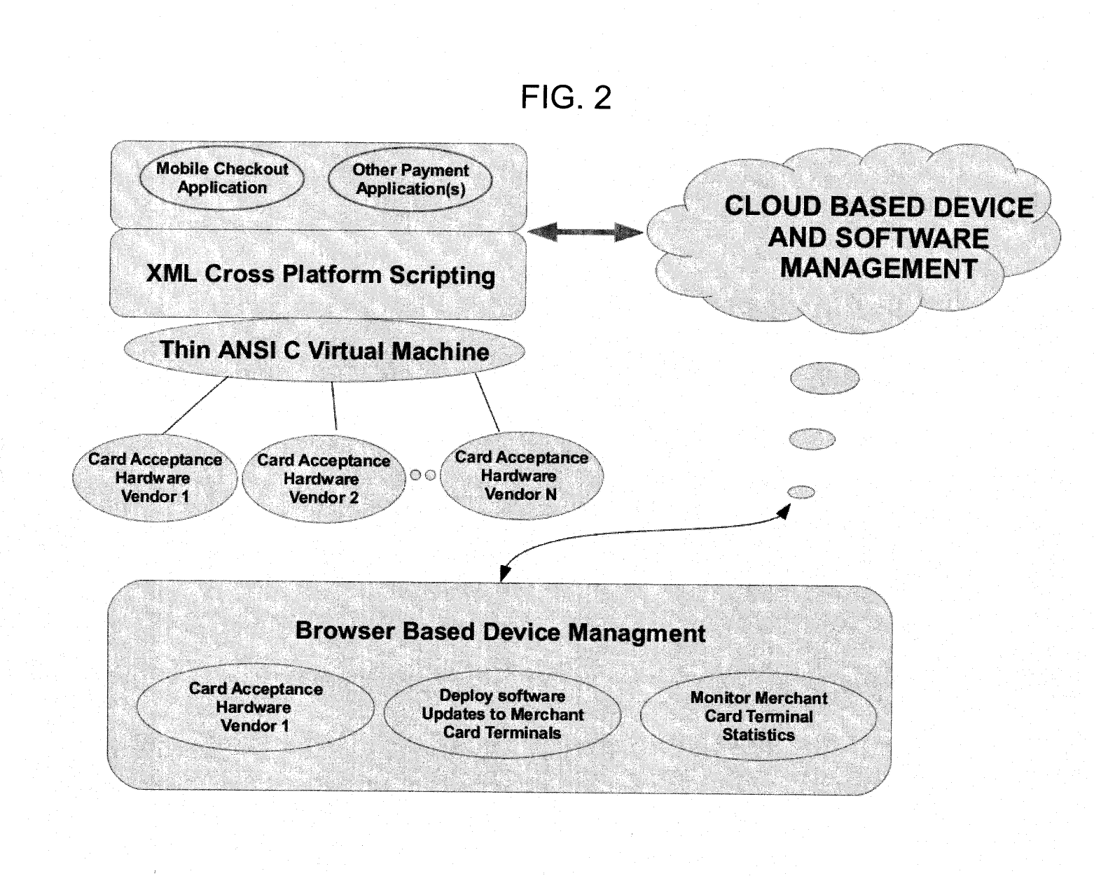

FIG. 2 shows a schematic for a cloud-based management system capable of remotely accessing the resident software to perform software updates and other software management tasks, which can be implemented in any of the preferred embodiments discussed herein.

I claim:

1. A process and architecture to conduct a financial transaction between a customer and a merchant, whereby the merchant's Point of Sale (POS) Terminal system is capable of interfacing with multiple mobile payment/wallet solutions and providing checkout functionality to a Customer for multiple corresponding mobile payment platforms, comprising
a) a point of sale (POS) Terminal (i.e. cash register) (“Terminal”) having either an internal or externally-connected card swiper unit via RS-232 or similar connection means for reading magnetic cards (i.e. credit cards), and having basic computer components and internet connectivity and telecommunication functions;
b) a software program resident in either a remote cloud server in communication with the Terminal or resident on the Terminal, said software program being activated upon receiving a total due from said Terminal and querying a series of mobile wallet/payment servers for completion of a transaction;
c) upon the customer's request to complete the transaction via mobile wallet/payment, the merchant selects from one of a series of a hotkeys on the Terminal corresponding to the appropriate mobile payment platform requested;
d) said software program then generates a specific code comprised of a matrix, QR, or barcode (“code”), said code corresponding to a specific mobile wallet/payment solution, and containing data comprising Merchant ID, POS/Terminal ID, total amount due, said code being optically displayed to the customer via Terminal's display means;
e) the customer scans said code using the customer's mobile payment application resident on the customer's mobile device (i.e. smart phone), said mobile device having optic scan function known in the art, thereby establishing communication between said Terminal software and the chosen Mobile Payment Solution (“MPS”) and enabling the selected MPS to clear the transaction;
f) MPS's Processor completes transaction, and transmits transaction settlement results to the MPS;
g) MPS responds to the settlement request received from the processor payment gateway with the settlement results obtained from the processor;
h) Processor responds back to the Merchant's POS Terminal unit and card swiper with the result of the transaction;
i) MPS transmits transaction results to the customer's mobile payment application; and
j) said Terminal software additionally comprising of a remote cloud-based back-end software suite enabling means for remotely updating, modifying, troubleshooting and maintenance services to said software.

2. A process and architecture to conduct a financial transaction between a customer and a merchant, whereby the merchant's Terminal or Point of Sale (POS) system is capable of interfacing with multiple mobile payment/wallet solutions and providing checkout functionality to the customer for multiple corresponding mobile payment platforms, comprising
a) a point of sale (POS) Terminal (i.e. cash register) (“Terminal”) having either an internal or externally-connected card swiper unit via RS-232 or similar connection means for reading magnetic cards (i.e. credit cards), and having basic computer components and internet connectivity and telecommunication functions;
b) a software program resident in either a remote cloud server in communication with the Terminal or resident on the Terminal, said software program being activated upon receiving a total due from said Terminal and querying a series of mobile wallet/payment servers for completion of a transaction;
c) a series of static matrix/QR code labels located within close proximity to the merchant POS/Terminal location;
I) said static matrix/QR code labels being printed on any suitable media (paper, transparency) and placed where visible to Customer using the mobile payment application;
II) said static matrix/QR code labels each containing data allowing for communication between said software and a mobile wallet/payment platform;
III) said static matrix/QR code label containing data comprising Merchant ID, POS Terminal ID, Merchant's Processor;
d) the Customer identifies and scans the appropriate the static matrix/QR code with customer's mobile payment application corresponding to the customer's preferred mobile payment solution;
e) said scanning of said static matrix/QR code triggers said software to transmit data via said Terminal to the Mobile Payment Server (“MPS”), said data containing merchant ID, POS terminal ID, customer ID and customer's financial instrument information (comprising data set 1) from the customer's mobile payment application, with a request to settle the transaction;
f) MPS receives merchant ID, POS terminal ID, total amount due from processor's payment gateway as a request for settlement (comprising data set 2);
g) MPS matches data set 1 and data set 2, verifying the ID information is identical, recombines the data sets upon verification, and forwards this recombined data along with the total amount due, customer ID, and customer payment method to the processor for settlement of the transaction;
h) Processor completes transaction, and transmits transaction settlement results to the MPS;
i) MPS responds to the settlement request received from the processor payment gateway with the settlement results obtained from the processor;
j) Processor responds back to the Merchant's POS Terminal unit and card swiper with the result of the transaction;
k) MPS transmits transaction results to the customer's mobile payment application; and
l) said Terminal software additionally comprising of a remote cloud-based back-end software suite enabling means for remotely updating, modifying, troubleshooting and maintenance services to said software.

3. A process and architecture to conduct a financial transaction between a customer and a merchant, whereby the merchant's Terminal or Point of Sale (POS) system is capable of interfacing with multiple mobile payment/wallet solutions and providing checkout functionality to the customer for multiple corresponding mobile payment platforms, comprising
a) a point of sale (POS) Terminal (i.e. cash register) (“Terminal”) having either an internal or externally-connected card swiper unit via RS-232 or similar connection means for reading magnetic cards (i.e. credit cards), and having basic computer components and internet connectivity and telecommunication functions;
b) a software program resident in either a remote cloud server in communication with the Terminal or resident on the Terminal, said software program being activated upon receiving a total due from said Terminal and querying a series of mobile wallet/payment servers for completion of a transaction;
c) said Terminal further having a near field communication (“NFC”) emitting device (i.e. radio wave, Bluetooth®), or similar NFC means known in the art,
d) said NFC emitting device set to receive communication from the customer's mobile device payment application and creating a short range NFC field by the Merchant's said Terminal/POS System;
e) the Customer initiates a communication handshake by waving the customer's NFC enabled mobile payment application in said NFC field, causing said NFC emitting device to send a signal to said software identifying the specific mobile wallet/payment application that the Customer wishes to use to complete a transaction, as wells as merchant ID, POS terminal ID, customer ID and customer's financial instrument information (comprising data set 1) from the mobile payment application and transmits this data to the MPS;
f) MPS receives merchant ID, POS terminal ID, total amount due from processor's payment gateway as a request for settlement (comprising data set 2);
g) MPS matches data set 1 and data set 2, verifying the ID information is identical, recombines the data sets upon verification, and forwards this recombined data along with the total amount due, customer ID, and customer payment method to the processor for settlement of the transaction;
h) Processor completes transaction, and transmits transaction settlement results to the MPS;
i) MPS responds to the settlement request received from the processor payment gateway with the settlement results obtained from the processor;
j) Processor responds back to the Merchant's POS Terminal unit and card swiper with the result of the transaction;
k) MPS transmits transaction results to the customer's mobile payment application; and
l) said Terminal software additionally comprising of a remote cloud-based back-end software suite enabling means for remotely updating, modifying, troubleshooting and maintenance services to said software.
